(19) United States
(12) Patent Application Publication
(10) Pub. No.: US 2018/0300750 A1
(43) Pub. Date: Oct. 18, 2018

(54) METHOD AND APPARATUS FOR DELIVERING MEDIA FILES

(71) Applicant: TENCENT TECHNOLOGY (SHENZHEN) COMPANY LIMITED, Shenzhen (CN)

(72) Inventors: Xiwang YANG, Shenzhen (CN); Chong PENG, Shenzhen (CN); Gong CHEN, Shenzhen (CN); Shi HUANG, Shenzhen (CN); Bifeng ZHANG, Shenzhen (CN)

(73) Assignee: TENCENT TECHNOLOGY (SHENZHEN) COMPANY LIMITED, Shenzhen (CN)

(21) Appl. No.: 16/012,564

(22) Filed: Jun. 19, 2018

Related U.S. Application Data
(63) Continuation of application No. PCT/CN2017/084897, filed on May 18, 2017.

(30) Foreign Application Priority Data
Jun. 2, 2016 (CN) 201610390304.2

(51) Int. Cl. G06Q 30/02

(52) U.S. Cl. CPC G06Q 30/0244; G06Q 30/0277; G06Q 30/0276; G06Q 30/0272

(57) ABSTRACT

Aspects of the disclosure provide a method for delivering a media file. A target delivery volume and an actual delivery volume of the media file corresponding to a same period of time are obtained. The target delivery volume is compared with the actual delivery volume to obtain a comparison result. A correlation parameter of the media file can be adjusted according to the comparison result. The correlation parameter can indicate a correlation between the media file and a delivery object of the media file. The media file can be delivered to the delivery object according to the adjusted correlation parameter.

### RELATED APPLICATION

This application is a continuation of International Application No. PCT/CN2017/084897, filed on May 18, 2017, which claims priority to Chinese Patent Application No. 201610390304.2, entitled “METHOD AND APPARATUS FOR DELIVERING MEDIA FILE” filed with the Patent Office of China on Jun. 2, 2016. The entire disclosures of the prior applications are hereby incorporated by reference in their entirety.

### FIELD OF THE TECHNOLOGY

The present disclosure relates to techniques for delivering a media file.

### BACKGROUND OF THE DISCLOSURE

With the rapid development of computer technologies, in the related technology, a media file may be delivered to a delivery object to increase an exposure volume of the delivered media file. For example, an advertisement of an application is delivered to an application user. However, to ensure the exposure volume of the media file, in the related technology, delivery of the media file is generally controlled by using a manner of adjusting the delivery probability of the media file. For example, when a delivery speed of an advertisement is relatively fast, the delivery probability of the advertisement is reduced. However, in the manner of adjusting the delivery probability of the media file, the media file may be delivered to a delivery object with a relatively low correlation.

For the foregoing problem, no effective solution is provided currently.

### SUMMARY

Aspects of the disclosure provide a method for delivering a media file. A target delivery volume and an actual delivery volume of the media file corresponding to a same period of time are obtained. The target delivery volume is compared with the actual delivery volume to obtain a comparison result. A correlation parameter of the media file can be adjusted according to the comparison result. The correlation parameter can indicate a correlation between the media file and a delivery object of the media file. The media file can be delivered to the delivery object according to the adjusted correlation parameter.

Aspects of the disclosure provide an apparatus. The apparatus can include processing circuitry configured to obtain a target delivery volume and an actual delivery volume of the media file corresponding to a same period of time. The processing circuitry can be further configured to compare the target delivery volume with the actual delivery volume to obtain a comparison result, and adjust a correlation parameter of the media file according to the comparison result. The correlation parameter indicates a correlation between the media file and a delivery object of the media file. The media file can be delivered to the delivery object according to the adjusted correlation parameter.

Aspects of the disclosure provide a non-transitory computer-readable medium storing a program. The program is executable by a processor to perform obtaining a target delivery volume and an actual delivery volume of the media file corresponding to a same period of time. The program is executable by the processor to further perform comparing the target delivery volume with the actual delivery volume to obtain a comparison result, and adjusting a correlation parameter of the media file according to the comparison result. The correlation parameter indicates a correlation between the media file and a delivery object of the media file. The media file can be delivered to the delivery object according to the adjusted correlation parameter.

### BRIEF DESCRIPTION OF THE DRAWINGS

The accompanying drawings described herein are used to provide further understanding of the present disclosure, and form a part of the present application. Exemplary embodiments of the present disclosure and descriptions of the exemplary embodiments are used to explain the present disclosure, and do not form an improper limitation to the present disclosure. In the accompanying drawings:

FIG. 1 is a schematic diagram of a hardware environment of a method for delivering a media file according to an embodiment of the present disclosure;

FIG. 2 is a flowchart of an optional method for delivering a media file according to an embodiment of the present disclosure;

FIG. 3 is a schematic diagram of an overall architecture of a method for delivering a media file according to an embodiment of the present disclosure;

FIG. 4 is a processing flowchart of advertisement delivery according to an embodiment of the present disclosure;

FIG. 5 is a schematic diagram of an optional apparatus for delivering a media file according to an embodiment of the present disclosure;

FIG. 6 is a schematic diagram of another optional apparatus for delivering a media file according to an embodiment of the present disclosure;

FIG. 7 is a schematic diagram of still another optional apparatus for delivering a media file according to an embodiment of the present disclosure;

FIG. 8 is a schematic diagram of yet another optional apparatus for delivering a media file according to an embodiment of the present disclosure; and

FIG. 9 is a structural block diagram of a terminal according to an embodiment of the present disclosure.

### DESCRIPTION OF EMBODIMENTS

To make a person skilled in the art understand the solutions in the present disclosure better, the following describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure shall fall within the protection scope of the present disclosure.

It should be noted that, the terms “first” and “second” in the specification and the claims of the present disclosure and the foregoing accompanying drawings are used to distinguish similar objects, and do not need to be used to describe a particular sequence or order. It should be understood that data used in this way is interchangeable in a suitable case, so that the embodiments of the present disclosure described herein can be implemented in a sequence in addition to the sequence shown or described herein. In addition, the terms “include”, “comprise”, and any variants thereof are intended to cover a non-exclusive inclusion. For example, a process, method, system, product, or device that includes a series of steps or elements is not limited to the steps or units that are clearly listed, but may include other steps or units that are not clearly listed or that are inherent to the process, method, product, or device.

### Embodiment 1

According to this embodiment of the present disclosure, a method embodiment of a method for delivering a media file is provided.

Optionally, in this embodiment, the method for delivering a media file may be applied to a hardware environment constructed by a server 102 and a terminal 104 shown in FIG. 1. As shown in FIG. 1, the server 102 is connected to the terminal 104 by using a network. The network includes, but is not limited to: a wide area network, a metropolitan area network, or a local area network. The terminal 104 is but is not limited to a PC, a mobile phone, a tablet computer, or the like. The method for delivering a media file in this embodiment of the present disclosure may be performed by the server 102, or may be performed by the terminal 104, or may be performed jointly by the server 102 and the terminal 104. The method for delivering a media file in this embodiment of the present disclosure may also be performed by a client installed on the terminal 104.

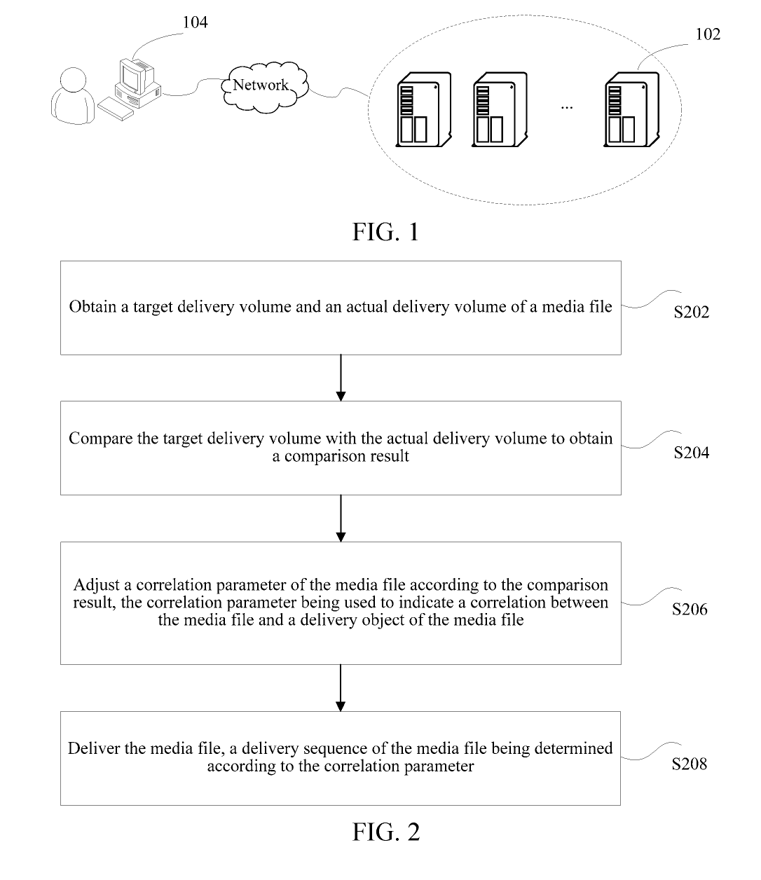

FIG. 2 is a flowchart of an optional method for delivering a media file according to an embodiment of the present disclosure. As shown in FIG. 2, the method may include the following steps:

Step S202. Obtain a target delivery volume and an actual delivery volume of a media file.

Step S204. Compare the target delivery volume with the actual delivery volume to obtain a comparison result.

Step S206. Adjust a correlation parameter of the media file according to the comparison result, the correlation parameter being used to indicate a correlation between the media file and a delivery object of the media file. For example, a delivery object can be an online user visiting a webpage on the Internet. The correlation parameter of the media file with respect to this user can be calculated based on content of the media file and content of the webpage the user is visiting. In alternative examples, the correlation parameter may be calculated in different ways. The calculated correlation parameter can be adjusted based on the comparison result.

Step S208. Deliver the media file, for example, based on the adjusted correlation parameter. A delivery sequence (or order) of the media file can be determined according to the adjusted correlation parameter. For example, a group of media files are to be delivered to a delivery object and each of the group of media files has a correlation parameter. A delivery order of a media file among the group of the media files that are to be delivered can be determined according to the respective correlation parameter. For example, a media file having a higher correlation parameter value may have a higher priority. After adjusting the correlation parameter of the media file being discussed at Step S206, a delivery order of the media file being discussed can be determined according to the adjusted correlation parameter. Accordingly, the media file can be delivered according to the determined delivery order among the group of media files.

Through the foregoing steps S202, S204, S206, S208, the correlation parameter of the media file is adjusted according to the comparison result between the target delivery volume and the actual delivery volume of the media file, and the media file is delivered according to the correlation (or indicated by the correlation parameter) between the media file and the delivery object, to resolve the technical problem of the related technology that the media file may be delivered to a delivery object with a relatively low correlation to ensure an exposure volume of the media file, to further achieve the technical effect of improving the delivery precision of the media file to further improve the delivery efficiency of the media file.

In the technical solution provided in step S202, this embodiment of the present disclosure does not specifically limit the type of the media file. The media file may be a video file, an audio file, a picture file, a text file, or the like, or may be any combination of the several files, for example, a combination of a text file and a picture file, or a combination of a video file and a text file. A specific product form may be a video advertisement, a native advertisement, a banner advertisement, a search advertisement, or the like. The media file may be a to-be-delivered file, the target delivery volume of the media file is the quantity of to-be-delivered media files that is predetermined, and the actual delivery volume of the media file is the quantity of media files actually delivered to the delivery object. Herein, it should be noted that, the delivery object of the media file may be a web page user, an application user, or the like. This embodiment of the present disclosure does not limit the type of the delivery object of the media file.

It should be noted that, the target delivery volume of the media file refers to the target delivery volume of the media file from a delivery start time to a current time, and the actual delivery volume of the media file similarly refers to the actual delivery volume of the media file from the delivery start time to the current time. The actual delivery volume of the media file to the current time may be recorded by using a counter, for example, at a server executing the delivery. Each time the media file is delivered, the counter is added by 1, and the actual delivery volume of the media file to the current time is a count value of the counter. It should be noted that, the foregoing manner of obtaining the actual delivery volume of the media file to the current time is only an optional embodiment of the embodiments of the present disclosure. In this embodiment of the present disclosure, the actual delivery volume of the media file to the current time may also be obtained by using another manner.

As an optional embodiment, the target delivery volume of the media file to the current time may be determined according to an exposure opportunity curve of the media file. It should be noted that, the exposure opportunity curve is the counted quantity, distributed with time, of media files requested by online users. A media file scheduling system may provide media file scheduling information. The media file scheduling information may include the following information: a delivery start time of the media file, a delivery end time of the media file, and a delivery volume of the media file corresponding to each time scale. The target delivery volume of the media file to the current time may be calculated according to the exposure opportunity curve of the media file and according to the following formula:

$$paced\_exp o = \frac{{\int }_{{t}_{start}}^{{t}_{curr}} c ( t ) dt}{{\int }_{{t}_{start}}^{{t}_{end}} c ( t ) dt} \times exp o\_num$$

where c(t) is an exposure opportunity curve of the media file, tₛₜₐᵣₜ is a delivery start time of the media file, t_{end} is a delivery end time of the media file, t_{curr} is a current time, expo_num is a total volume of to-be-delivered media files, and paced_expo is the target delivery volume of the media file from the delivery start time to the current time.

It should be noted that, the foregoing manner of obtaining the target delivery volume of the media file to the current time is only an optional embodiment of the embodiments of the present disclosure. In this embodiment of the present disclosure, the target delivery volume of the media file to the current time may also be obtained by using another manner. In the optional embodiment, the target delivery volume of the media file to the current time is obtained by using the exposure opportunity curve of the media file. Compared with another obtaining manner, the exposure opportunity curve obtained according to pulls (or requests) by users is more convenient, and the exposure opportunity curve can accurately reflect a delivery process of the media file. Therefore, obtaining the target delivery volume of the media file to the current time by using the exposure opportunity curve is more convenient and effective, and the accuracy of the obtained target delivery volume can be ensured.

In this embodiment of the present disclosure, the manner of obtaining the target delivery volume and the actual delivery volume of the media file is not specifically limited provided that a variation manner and a replacement manner of obtaining the target delivery volume and the actual delivery volume of the media file to the current time fall within the protection scope of the present disclosure.

In the technical solution provided by step S204, after the target delivery volume and the actual delivery volume of the media file to the current time are obtained by using step S202, in this embodiment of the present disclosure, the obtained target delivery volume may be compared with the obtained actual delivery volume, to compare a magnitude relationship between the target delivery volume and the actual delivery volume to obtain a comparison result. It should be noted that, the comparison result obtained by comparing the target delivery volume with the actual delivery volume may include the following several cases: The actual delivery volume is less than the target delivery volume; the actual delivery volume is greater than the target delivery volume; and the actual delivery volume is equal to the target delivery volume. The foregoing three cases may reflect the delivery speed of the media file. Specifically, when the actual delivery volume is less than the target delivery volume, it indicates that the delivery speed of the media file is excessively slow; when the actual delivery volume is greater than the target delivery volume, it indicates that the delivery speed of the media file is excessively fast; and when the actual delivery volume is equal to the target delivery volume, it indicates that the delivery speed of the media file is suitable, and when the media file is delivered according to the delivery speed, a total volume of predetermined to-be-delivered media files may be completed in a time period from the delivery start time to the delivery end time. By comparing the actual delivery volume with the target delivery volume, the delivery speed of the media file can be controlled according to the comparison result.

Optionally, the comparison result obtained by comparing the target delivery volume with the actual delivery volume may further include a difference value between the actual delivery volume and the target delivery volume. That is, when the actual delivery volume is less than the target delivery volume, the actual delivery volume is less than the value of the target delivery volume; and when the actual delivery volume is greater than the target delivery volume, the actual delivery volume is greater than the value of the target delivery volume. By comparing the difference value between the actual delivery volume and the target delivery volume, the delivery speed of the media file can be adjusted more accurately.

In the technical solution provided by step S206, the comparison result obtained by comparing the target delivery volume with the actual delivery volume of the media file may affect the correlation between the media file and the delivery object of the media file. For example, the comparison result may be used as a basis for adjusting the correlation parameter value indicating the correlation between the media file and the delivery object of the media file. The correlation between the media file and the delivery object of the media file may be directly indicated by the correlation parameter of the media file. A larger correlation parameter of the media file indicates a higher correlation between the media file and the delivery object; and a smaller correlation parameter of the media file indicates a lower correlation between the media file and the delivery object. It should be noted that, correlations between multiple different media files and a same delivery object may be different, and correlations between a same media file and different delivery objects may be different. The correlation between the media file and the delivery object of the media file may affect the delivery sequence (or order) of the media file (e.g., the correlation between the media file and the delivery object of media file may be used as a basis for determination of the delivery order of the media file), and a media file with a higher correlation to the delivery object has a higher priority than a media file with a lower correlation to the delivery object in a group of media files to be delivered to the delivery object. It should be noted that, a same media file may be delivered to a same delivery object. The number of delivery times may be set according to an actual application scenario; or multiple different media files may be delivered to a same delivery object, and correlations between the media files and the delivery object are different. That is, correlation parameters of the media files are different, and correspondingly, priorities of delivery sequences (or orders) for delivering the media files to the delivery object are different.

For example, the delivery object is user A, and media files to be delivered to user A are separate advertisement 1, advertisement 2, and advertisement 3. If a descending sequence (or order) of correlations between the advertisements and user A is advertisement 1, advertisement 2, and advertisement 3, correspondingly, a descending priority of a delivery sequence (or order) for delivering advertisements to user A is advertisement 1, advertisement 2, and advertisement 3.

The comparison result between the actual delivery volume and the target delivery volume of the media file may reflect the correlation between the media file and the delivery object. Specifically, when the actual delivery volume of the media file is less than the target delivery volume, if the media file can win exposure of the delivery object, it indicates that the correlation between the media file and the delivery object is relatively high; and when the actual delivery volume of the media file is greater than the target delivery volume, if the media file cannot win exposure of the delivery object, it indicates that the correlation between the media file and the delivery object is relatively low.

In this embodiment of the present disclosure, the correlation parameter of the media file is dynamically adjusted according to the comparison result between the target delivery volume and the actual delivery volume of the media file, so as to dynamically adjust the correlation between the media file and the delivery object to further adjust the delivery sequence (or order) of the media file.

As an optional embodiment, step S206 of adjusting a correlation parameter of the media file according to the comparison result may include the following sub-steps:

Step S206, sub-step 1. Increase the value of the correlation parameter when the comparison result indicates that the actual delivery volume is less than the target delivery volume. As a result, a delivery sequence (or order) determined by the correlation parameter before the value is increased can be later than a delivery sequence (or order) determined by the correlation parameter after the value is increased.

Step S206, sub-step 3. Decrease the value of the correlation parameter when the comparison result indicates that the actual delivery volume is greater than the target delivery volume. As a result, a delivery sequence determined by the correlation parameter before the value is decreased can be earlier than a delivery sequence determined by the correlation parameter after the value is decreased.

It should be noted that, the comparison result obtained by comparing the target delivery volume with the actual delivery volume of the media file may include: The actual delivery volume is less than or greater than the target delivery volume. When the actual delivery volume is less than the target delivery volume (e.g., the actual delivery volume is less than the target delivery volume by a first preset threshold), in this embodiment of the present disclosure, the correlation between the media file and the delivery object may be increased, and thus it is more likely that the media file can be delivered. That is, when the correlation between the media file and the delivery object is relatively high, the media file needs to be preferentially delivered. In this case, in this embodiment of the present disclosure, the value of the correlation parameter of the media file may be increased to increase the priority of the delivery sequence (or order) of the media file, so that the delivery sequence (or order) corresponding to the correlation indicated after the value of the correlation parameter of the media file is increased is earlier than the delivery sequence (or order) corresponding to the correlation indicated before the value is increased. When the actual delivery volume is greater than the target delivery volume (e.g., the actual delivery volume is greater than the target delivery volume by a second preset threshold, where both the first preset threshold and the second preset threshold are greater than 0, and the first preset threshold and the second preset threshold may be the same or different), it indicates that the media file should not be exposed by the delivery object. That is, when the correlation between the media file and the delivery object should be relatively low, the media file needs to be delivered in a later sequence (or order). In this case, in this embodiment of the present disclosure, the value of the correlation parameter of the media file may be decreased to reduce the priority of the delivery sequence (or order) of the media file, so that the delivery sequence corresponding to the correlation indicated after the value of the correlation parameter of the media file is decreased is later than the delivery sequence corresponding to the correlation indicated before the value is decreased. It should be noted that, this embodiment of the present disclosure does not specifically limit the first preset threshold and the second preset threshold, and the first preset threshold and the second preset threshold may be set according to an actual requirement. Further, it should be noted that, a difference value by which the actual delivery volume of the media file is less than the target delivery volume may be the same as or may be different from a difference value by which the actual delivery volume is greater than the target delivery volume. This is not specifically limited herein.

In this embodiment of the present disclosure, the value of the correlation parameter of the media file is adjusted according to the comparison result between the actual delivery volume and the target delivery volume of the media file, to adjust the delivery sequence of the media file, so that a media file with a higher correlation to the delivery object may be preferentially delivered, and a media file with a lower correlation to the delivery object may be delivered later, so as to achieve the effect of increasing an exposure rate of the media file to improve the delivery efficiency of the media file.

In the technical solution provided by step S208, the correlation parameter of the media file may be used to indicate the correlation between the media file and the delivery object. In this embodiment of the present disclosure, in a group of media files to be delivered to a delivery object, the delivery sequence (or order) of the media file with a higher correlation to the delivery object is put ahead, the delivery sequence of the media file with a lower correlation to the delivery object is put behind, and the group of media files are delivered to the delivery object according to the adjusted delivery sequences. It should be noted that, there may be one or more media files delivered to a delivery object. When multiple media files are delivered to a delivery object, delivery sequences of the media files may be adjusted according to values of correlation parameters of the media files, so that a media file with a larger value of the correlation parameter is preferentially delivered, to increase the exposure rate of the delivery object for the media file to improve the delivery efficiency of the media file. In some examples, a media file with a smaller value of the correlation parameter may be dropped from the group of media files to be delivered to the delivery object.

Optionally, in this embodiment of the present disclosure, when the media file is delivered to the delivery object according to the delivery sequence corresponding to the correlation indicated by a related parameter of the media file, a delivery manner may be selected according to the type of the delivery object. This embodiment of the present disclosure does not specifically limit the type of the delivery object, which may be a web page user, an application user, or the like. This embodiment of the present disclosure also does not specifically limit the delivery manner of delivering the media file to the delivery object. The media file may be automatically displayed in a pop-up form, or a user may be prompted to view the delivered media file in a message prompt form, or the delivered media file may be displayed when an application starts. The delivery manner of the media file may be set or adjusted according to the type of the media file, the type of the delivery object, and the type of a terminal in which the delivery object is located.

As an optional embodiment, step S206 of adjusting a correlation parameter of the media file according to the comparison result may include the following sub-steps:

Step S206, sub-step 2. Adjust a delivery control parameter according to the comparison result to obtain an adjusted delivery control parameter, the comparison result being used to increase or decrease the value of the delivery control parameter by a first preset proportion.

In the technical solution provided by step S206, sub-step 2, the delivery control parameter may be used to indicate a delivery speed of the media file. The value of the delivery control parameter may be adjusted according to the comparison result between the actual delivery volume and the target delivery volume of the media file. Specifically, when the actual delivery volume of the media file is less than the target delivery volume, it indicates that the delivery speed of the media file at this time is excessively slow, and the value of the delivery control parameter needs to be increased; and when the actual delivery volume of the media file is greater than the target delivery volume, it indicates that the delivery speed of the media file at this time is excessively fast, and the value of the delivery control parameter needs to be decreased. Optionally, the increase or decrease amplitude of the value of the delivery control parameter may be determined according to the difference value between the actual delivery volume and the target delivery volume of the media file. In this embodiment of the present disclosure, optionally, the value of the delivery control parameter is increased or decreased by a first preset proportion. The amplitude of the first preset proportion may be determined according to the difference value between the actual delivery volume and the target delivery volume of the media file. For example, the first preset proportion may be 0.5%. It should be noted that, the proportions by which the value of the delivery control parameter is increased and decreased may be the same, and are a first preset proportion, or may be different. The proportions by which the value of the delivery control parameter may be specifically set according to an actual situation, and are not specifically limited in this embodiment of the present disclosure.

Step S206, sub-step 4. Adjust a correlation parameter of the media file according to the adjusted delivery correlation parameter, the adjusted delivery correlation parameter being used to increase or decrease the value of the correlation parameter by a second preset proportion.

In the technical solution provided by sub-step 4 of step S206, in the present disclosure, the correlation parameter of the media file may be adjusted according to the adjusted delivery control parameter. When the delivery control parameter is increased by the first preset proportion, the value of the correlation parameter of the media file may be correspondingly increased by the second preset proportion; and when the delivery control parameter is decreased by the first preset proportion, the value of the correlation parameter of the media file may be correspondingly decreased by the second preset proportion. It should be noted that, the first preset proportion may be the same as or may be different from the second preset proportion. This embodiment of the present disclosure does not specifically limit the second preset proportion, which may be set or adjusted according to an actual situation.

It should be noted that, when the actual delivery volume of the media file is less than the target delivery volume, it indicates that the delivery speed of the media file is excessively slow, the media file may be exposed by the delivery object, and the correlation between the media file and the delivery object is relatively high. In this case, the value of the delivery control parameter needs to be increased, and the increased proportion may be the first preset proportion, so that the value of the correlation parameter of the media file is increased, and the increased proportion may be the second preset proportion, so that it may be ensured that the media file can be preferentially delivered to the delivery object, to improve the efficiency of the media file. On the contrary, when the actual delivery volume of the media file is greater than the target delivery volume, it indicates that the delivery speed of the media file is excessively fast, the media file cannot be exposed by the delivery object, and the correlation between the media file and the delivery object is relatively low. In this case, the value of the delivery control parameter needs to be decreased, and the decreased proportion may be the first preset proportion, so that the value of the correlation parameter of the media file is decreased, and the decreased proportion may be the second preset proportion, so that it may be ensured that the delivery sequence of the media file with a lower correlation to the delivery object is put forward, to ensure preferentially delivering the media file with a higher correlation to the delivery object and with the forward sequence, to further improve the efficiency of the media file.

As an optional embodiment, the correlation parameter of the media file may be adjusted according to the following formula:

score(u,ad)=score(u,ad)×a,

where score(u,ad) is the correlation parameter of the media file, and α is the delivery control parameter, used to indicate a delivery speed of the media file, where

$$α = \{ \begin{matrix}α \times {β}^{+} , & \begin{matrix}The actual delivery volume is less \\ than the target delivery volume\end{matrix} \\ α \times {β}^{-} , & \begin{matrix}The actual delivery volume is greater \\ than the target delivery volume\end{matrix}\end{matrix}$$

where β⁺ is a first coefficient, β⁺>1, β⁻ is a second coefficient, and β⁻<1.

It should be noted that, an initial value of the delivery control parameter α may be 1, a change interval of α may be [1, 5], β⁺ is a coefficient greater than 1 and the value may be 1.05, and β⁻ may be a coefficient less than 1 and the value may be 0.95. It should be noted that, the values of the foregoing parameters are all an optional embodiment of the present disclosure. The values of the foregoing parameters may also be adjusted according to a situation. When the actual delivery volume of the media file is less than the target delivery volume (e.g., the actual delivery volume is less than the target delivery volume by the first preset threshold), the value of the delivery control parameter α may be increased by the first preset proportion, so that the correlation parameter score(u,ad) of the media file may also be increased by the second preset proportion. When the actual delivery volume of the media file is greater than the target delivery volume (e.g., the actual delivery volume is greater than the target delivery volume by the first preset threshold), the value of the delivery control parameter α may be decreased by the first preset proportion, so that the correlation parameter score(u,ad) of the media file may also be decreased by the second preset proportion. It should be noted that, u in the correlation parameter score(u,ad) may represent a user who initiates a media file delivery request, and ad may represent a media file requested by the user, such as an advertisement.

It should be noted that, the foregoing manner of calculating the correlation parameter of the media file is only an optional embodiment of the embodiments of the present disclosure. In this embodiment of the present disclosure, the correlation parameter of the media file may also be calculated by using another manner. In the optional embodiment, by calculating the correlation parameter of the media file, the priority of the delivery sequence of the media file may be adjusted according to the correlation parameter, so that a media file with a higher correlation to the delivery object is preferentially delivered, to achieve the effect of improving an exposure volume of multimedia to further improve the delivery efficiency of the media file.

As an optional embodiment, step S202 of obtaining a target delivery volume and an actual delivery volume of a media file may include: Step S202, sub-step 2. Obtain the target delivery volume and the actual delivery volume of the media file every once in a preset time. Step S204 of comparing the target delivery volume with the actual delivery volume to obtain a comparison result may include: Step S204, sub-step 2. Compare the target delivery volume with the actual delivery volume every once in the preset time. Step S206 of adjusting a correlation parameter of the media file according to the comparison result may include: Step S206, sub-step 2. Adjust the correlation parameter of the media file according to the comparison result every once in the preset time.

It should be noted that, the preset time in the optional embodiment may be set or adjusted according to an actual situation. The preset time may be 1 minute, 30 seconds, or the like, and is not specifically limited herein. In the method for delivering a media file in the optional embodiment, the foregoing steps are performed every once in a preset time, to adjust the correlation parameter of the media file every once in the preset time, to achieve the effect of improving the accuracy of the correlation parameter of the media file, to improve the precision of adjusting the delivery sequence of the media file.

The present disclosure further provides an embodiment, and a media file in the embodiment is described by using a contract advertisement as an example.

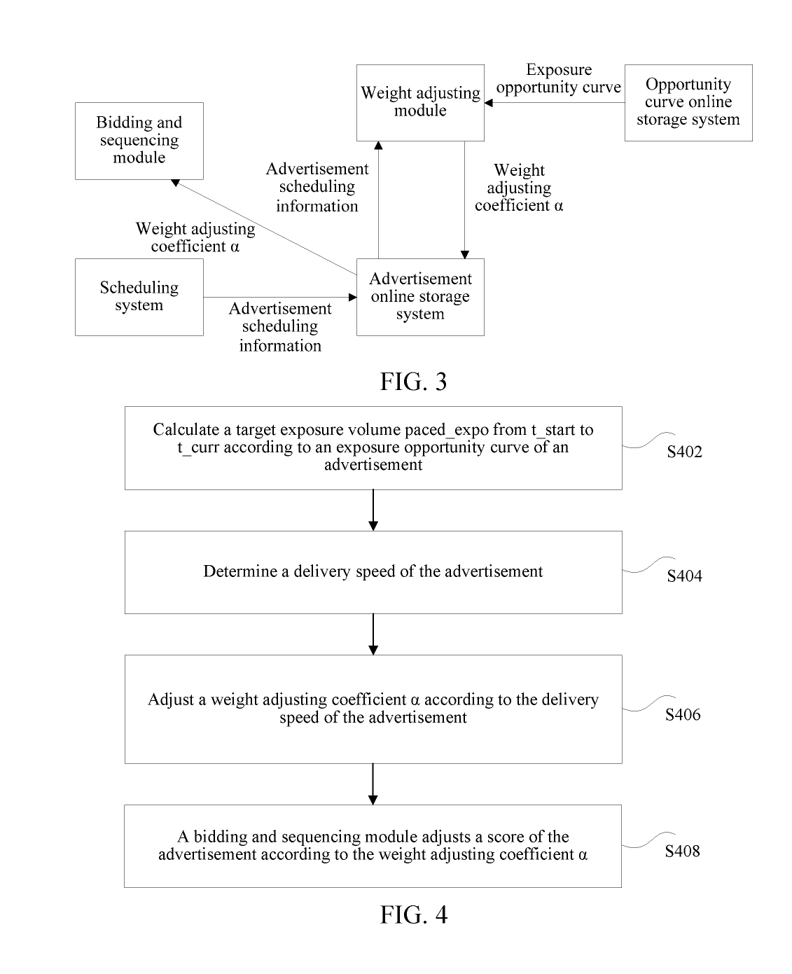

FIG. 3 is a schematic diagram of an overall architecture of a method for delivering a media file according to an embodiment of the present disclosure. As shown in FIG. 3, an advertisement online storage system may obtain everyday advertisement scheduling information of each contract advertisement from a scheduling system, including an exposure volume that should be completed, that is, a delivery volume. A weight adjusting module may obtain the advertisement scheduling information from the advertisement online storage system, including an exposure volume that should be completed by each advertisement every day and an exposure volume that has been consumed so far, that is, an actual delivery volume so far. In addition, the weight adjusting module may further obtain an exposure opportunity curve of the contract advertisement from an opportunity curve online storage system. The weight adjusting module calculates a weight adjusting coefficient α that affects an advertisement sequencing indicator (or the correlation parameter) score (u, ad) according to the exposure opportunity curve of the contract advertisement, the exposure volume that should be completed every day by the contract advertisement, and the exposure volume that has been consumed so far. The weight adjusting coefficient α is the delivery control parameter α in the foregoing embodiments of the present disclosure, and sends the weight adjusting coefficient α to the advertisement online storage system for storage. A bidding and sequencing module reads the weight adjusting coefficient α from the advertisement online storage system in real time, and adjusts the advertisement sequencing indicator score (u, ad). The adjusting manner may be: score(u, ad)=score(u, ad)×α.

Herein, it should be noted that, for the exposure opportunity curve of the advertisement, exposure distribution in different cities every day in a week may be calculated. Each opportunity curve may be given in a time sequence manner, and by using each minute as a granularity, and every day has a total of 1440 exposure volume points. The exposure opportunity curve of the advertisement is stored in the opportunity curve online storage system. By using a time dimension opportunity curve as an example, a key value may be {“Mon”, “Tue”, “Wed”, “Thu”, “Fri”, “Sat”, “Sun”}+“OppCurve”, and Value may be a time sequence value. The exposure opportunity curve of the advertisement may be generated by means of routinization, and may be updated every day according to exposure statistics in a latest month. The weight adjusting module reads the exposure opportunity curve of the advertisement from the opportunity curve online storage system. The exposure opportunity curve of the advertisement may be subdivided according to multiple dimensions, for example, may be subdivided according to a single dimension such as which day in a week, cities, user age groups, user gender, or user interests, or may be subdivided according to a multi-dimension combination.

Input data of the weight adjusting module may include the advertisement scheduling information and the exposure opportunity curve of the advertisement obtained from the advertisement online storage system, specifically including the following content: an exposure start time t_start, an exposure end time t_end, and a needed exposure volume expo_num. In addition, the weight adjusting module may further record an actual exposure volume curr_expo from the exposure start time t_start to the current time t_curr.

FIG. 4 is a processing flowchart of advertisement delivery according to an embodiment of the present disclosure. As shown in FIG. 4, a processing process of the weight adjusting module may include the following steps:

Step S402. Calculate a target exposure volume paced_expo from t_start to t_curr according to an exposure opportunity curve of an advertisement. A specific calculation formula is as follows:

$$paced\_exp o = \frac{{\int }_{{t}_{start}}^{{t}_{curr}} c ( t ) dt}{{\int }_{{t}_{start}}^{{t}_{end}} c ( t ) dt} \times exp o\_num$$

where c(t) is the exposure opportunity curve of the advertisement at that day.

Step S404. Determine a delivery speed of the advertisement.

If curr_expo<paced_expo×under_delivery_coeff, the advertisement delivery is excessively slow, that is, underdelivery; and if curr_expo>paced_expo×over_delivery_coeff, the advertisement delivery is excessively fast, that is, overdelivery. The value of under_delivery_coeff is a real number close to 1 but less than 1, such as 0.95, and the value of over_delivery_coeff is a real number close to 1 but greater than 1, such as 1.05.

Step S406. Adjust a weight adjusting coefficient α according to the delivery speed of the advertisement, where the weight adjusting coefficient α may be adjusted according to the following formula:

$$α = \{ \begin{matrix}α \times {β}^{+} , & if underdelivery \\ α \times {β}^{-} , & if overdelivery\end{matrix}$$

where 1≤α≤5, β⁺=1.05, β⁻=0.95, an initial value of α is set to 1, and α is set to be adjusted once every minute. The values of the foregoing parameters and an interval time for adjusting α are an optional embodiment, but it does not represent that the values of the parameters and the interval time for adjusting α have only the foregoing one value.

Step S408. A bidding and sequencing module adjusts a score of the advertisement according to the weight adjusting coefficient α, where the score of the advertisement is the correlation parameter of the media file in the foregoing embodiments of the present disclosure, and a specific adjusting manner may be according to the following formula:

score(u,ad)=score(u,ad)×α

A contract advertisement quantity (or delivery volume) guarantee problem in an advertisement delivery process of the embodiment may be jointly implemented by using the scheduling system and the weight adjusting module. The scheduling system gives a volume that is of each contract advertisement and that needs to be exposed every day. The weight adjusting module determines the current delivery speed of the advertisement by using the exposure opportunity curve of the advertisement. The weight adjusting module correspondingly increases or decreases adjusting of the score of the contract advertisement to control the delivery speed of the advertisement. Specifically, the weight adjusting module compares the actual delivery volume calculated in real time according to the advertisement with the current target delivery volume calculated according to the exposure opportunity curve, to calculate the weight adjusting coefficient α, where the score of the advertisement is adjusted according to the value of the weight adjusting coefficient α.

In an embodiment of the present disclosure, quantity guarantee is performed on the contract advertisement by using the weight adjusting manner. Compared with the related contract advertisement quantity guarantee manner, the embodiment can help an advertiser to maximize the efficiency. In the related advertisement quantity guarantee manner, correlations between current users and current advertisements are not distinguished among different media files, that is, the advertisement is not selectively exposed to users with a high correlation on the premise of quantity guarantee. In the related quantity guarantee manner, advertisement delivery is controlled by using a throttling probability associated with a media file when an amount of exposures is large during a specific time period in a day, that is, the advertisement is determined to be delivered or not delivered at a certain probability. For example, a media file can be assigned with a probability to control a delivery volume of the media file. Thus, the media file, even having a high correlation parameter value for a delivery object, may still be dropped if the media file were not selected by the probability. In such a random manner of throttling the delivery volume, the correlation between the current online user and the advertisement is not considered. Different from the related technology, the weight adjusting manner is used in the embodiment. When a network visiting traffic is high at a certain time during a day, and the advertisement delivery is excessively fast, the value of the weight adjusting coefficient α of the advertisement can be reduced; and when the advertisement delivery is excessively slow, the value of the weight adjusting coefficient α of the advertisement can be increased. If the user has a high score (or correlation parameter value) for the advertisement, the advertisement may still win exposure of the user according to the respective high correlation value. However, for a user has a low score for the advertisement, the advertisement may not be exposed. In other words, whether the media file is delivered or not is determined according to the adjusted correlation parameters instead of a probability. In this way, it can be ensured that the advertisement wins a user when having a higher correlation to the advertisement, and releases a user when having a lower correlation, so as to maximize the efficiency of the advertiser.

It should be noted that, for ease of description, the foregoing method embodiments are described as a series of action combinations. However, a person skilled in the art should understand that the present disclosure is not limited to the described sequence of the actions, because some steps may be performed in another sequence or performed at the same time according to the present disclosure. In addition, a person skilled in the art should also know that all the embodiments described in this specification are exemplary embodiments, and the related actions and modules are not necessarily required in the present disclosure.

Based on the foregoing descriptions of the embodiments, a person skilled in the art may clearly understand that the method according to the foregoing embodiment may be implemented by software in addition to necessary universal hardware or certainly by hardware. Based on such an understanding, the technical solutions of the present disclosure may be implemented in a form of a software product. The computer software product is stored in a storage medium (such as a ROM/RAM, a magnetic disk, or an optical disc), and includes several instructions for instructing a terminal device (which may be a mobile phone, a personal computer, a server, a network device, or the like) to perform the methods described in the embodiments of the present disclosure.

### Embodiment 2

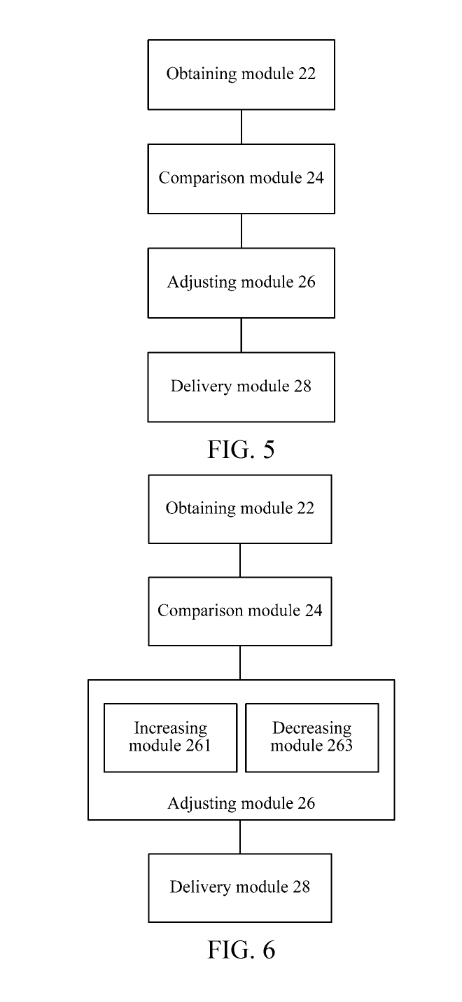

According to this embodiment of the present disclosure, an apparatus for delivering a media file that is configured to implement the foregoing method for delivering a media file is further provided. FIG. 5 is a schematic diagram of an optional apparatus for delivering a media file according to an embodiment of the present disclosure. As shown in FIG. 5, the apparatus may include:

an obtaining module 22, configured to obtain a target delivery volume and an actual delivery volume of a media file; a comparison module 24, configured to compare the target delivery volume with the actual delivery volume to obtain a comparison result; an adjusting module 26, configured to adjust a correlation parameter of the media file according to comparison result, the correlation parameter being used to indicate a correlation between the media file and a delivery object of the media file; and a delivery module 28, configured to deliver the media file, a delivery sequence of the media file being determined according to the correlation parameter.

It should be noted that, the obtaining module 22 in this embodiment may be configured to perform step S202 in Embodiment 1 of the present application, the comparison module 24 in this embodiment may be configured to perform step S204 in Embodiment 1 of the present application, the adjusting module 26 in this embodiment may be configured to perform step S206 in Embodiment 1 of the present application, and the delivery module 28 in this embodiment may be configured to perform step S208 in Embodiment 1 of the present application.

Herein, it should be noted that, the examples and application scenarios implemented by the foregoing modules and corresponding steps are the same, but are not limited to the content disclosed in the foregoing Embodiment 1. It should be noted that, the foregoing modules may run in the hardware environment shown in FIG. 1 as a part of the apparatus, may be implemented by using software, or may be implemented by using hardware. The hardware environment includes a network environment.

The foregoing modules may be used to resolve the technical problem of the related technology that the media file may be delivered to a delivery object with a relatively low correlation to ensure an exposure volume of the media file, to further achieve the technical effect of improving the delivery precision of the media file to further improve the delivery efficiency of the media file.

In the technical solution provided by the obtaining module 22, this embodiment of the present disclosure does not specifically limit the type of the media file, and the media file may be an advertisement, an audio file, a video file, or the like. The media file may be a to-be-delivered file, the target delivery volume of the media file is the quantity of to-be-delivered media files that is predetermined with the delivery object, and the actual delivery volume of the media file is the quantity of media files actually delivered to the delivery object. Herein, it should be noted that, the delivery object of the media file may be a web page user, an application user, or the like. This embodiment of the present disclosure does not limit the type of the delivery object of the media file.

It should be noted that, the target delivery volume and the actual delivery volume of the media file refer to the target delivery volume and the actual delivery volume of the media file from a delivery start time to a current time. The actual delivery volume of the media file to the current time may be recorded by using a counter. Each time the media file is delivered, the counter is added by 1, and the actual delivery volume of the media file to the current time is a count vale of the counter. It should be noted that, the foregoing manner of obtaining the actual delivery volume of the media file to the current time is only an optional embodiment of the embodiments of the present disclosure. In this embodiment of the present disclosure, the actual delivery volume of the media file to the current time may also be obtained by using another manner.

As an optional embodiment, the target delivery volume of the media file to the current time may be determined according to an exposure opportunity curve of the media file. It should be noted that, the exposure opportunity curve is the counted quantity, distributed with time, of media files requested by a user when the user comes online. A media file scheduling system may provide media file scheduling information. The media file scheduling information may include the following information: a delivery start time of the media file, a delivery end time of the media file, and a delivery volume of the media file corresponding to each time scale. The target delivery volume of the media file to the current time may be calculated according to the exposure opportunity curve of the media file and according to the following formula:

$$paced\_exp o = \frac{{\int }_{{t}_{start}}^{{t}_{curr}} c ( t ) dt}{{\int }_{{t}_{start}}^{{t}_{end}} c ( t ) dt} \times exp o\_num$$

< where c(t) is an exposure opportunity curve of the media file, tₛₜₐᵣₜ is a delivery start time of the media file, t_{end} is a delivery end time of the media file, t_{curr} is a current time, expo_num is a total volume of to-be-delivered media files, and paced_expo is the target delivery volume of the media file from the delivery start time to the current time.

It should be noted that, the foregoing manner of obtaining the target delivery volume of the media file to the current time is only an optional embodiment of the embodiments of the present disclosure. In this embodiment of the present disclosure, the target delivery volume of the media file to the current time may also be obtained by using another manner. In the optional embodiment, the target delivery volume of the media file to the current time is obtained by using the exposure opportunity curve of the media file. Compared with another obtaining manner, the exposure opportunity curve obtained according to pull by a user is more convenient, and the exposure opportunity curve can accurately reflect a delivery process of the media file. Therefore, obtaining the target delivery volume of the media file to the current time by using the exposure opportunity curve is more convenient and effective, and the accuracy of the obtained target delivery volume can be ensured.

In this embodiment of the present disclosure, the manner of obtaining the target delivery volume and the actual delivery volume of the media file is not specifically limited provided that a variation manner and a replacement manner of obtaining the target delivery volume and the actual delivery volume of the media file to the current time fall within the protection scope of the present disclosure.

In the technical solution provided by the comparison module 24, after the target delivery volume and the actual delivery volume of the media file to the current time are obtained by using the obtaining module 22, in this embodiment of the present disclosure, the obtained target delivery volume may be compared with the obtained actual delivery volume, to compare a magnitude relationship between the target delivery volume and the actual delivery volume to obtain a comparison result. It should be noted that, the comparison result obtained by comparing the target delivery volume with the actual delivery volume may include the following several cases: The actual delivery volume is less than the target delivery volume; the actual delivery volume is greater than the target delivery volume; and the actual delivery volume is equal to the target delivery volume. The foregoing three cases may reflect the delivery speed of the media file. Specifically, when the actual delivery volume is less than the target delivery volume, it indicates that the delivery speed of the media file is excessively slow; when the actual delivery volume is greater than the target delivery volume, it indicates that the delivery speed of the media file is excessively fast; and when the actual delivery volume is equal to the target delivery volume, it indicates that the delivery speed of the media file is suitable, and when the media file is delivered according to the delivery speed, a total volume of predetermined to-be-delivered media files may be completed in a time period from the delivery start time to the delivery end time. By comparing the actual delivery volume with the target delivery volume, the delivery speed of the media file can be controlled according to the comparison result.

Optionally, the comparison result obtained by comparing the target delivery volume with the actual delivery volume may further include a difference value between the actual delivery volume and the target delivery volume. That is, when the actual delivery volume is less than the target delivery volume, the actual delivery volume is less than the value of the target delivery volume; and when the actual delivery volume is greater than the target delivery volume, the actual delivery volume is greater than the value of the target delivery volume. By comparing the difference value between the actual delivery volume and the target delivery volume, the delivery speed of the media file can be adjusted more accurately.

In the technical solution provided by the adjusting module 26, the comparison result obtained by comparing the target delivery volume with the actual delivery volume of the media file may affect the correlation between the media file and the delivery object of the media file. The correlation between the media file and the delivery object of the media file may be directly indicated by the correlation parameter of the media file. A larger correlation parameter of the media file indicates a higher correlation between the media file and the delivery object; and a smaller correlation parameter of the media file indicates a lower correlation between the media file and the delivery object. It should be noted that, correlations between multiple different media files and a same delivery object may be different, and correlations between a same media file and different delivery objects may be different. The correlation between the media file and the delivery object of the media file may affect the delivery sequence of the media file, and a delivery sequence of a media file with a higher correlation to the delivery object has a higher priority than that of a media file with a lower correlation to the delivery object. It should be noted that, a same media file may be delivered to a same delivery object. The number of delivery times may be set according to an actual application scenario; or multiple different media files may be delivered to a same delivery object, and correlations between these media files and the delivery object are different. That is, correlation parameters of the media files are different, and correspondingly, priorities of delivery sequences for delivering the media files to the delivery object are different.

For example, the delivery object is user A, and media files delivery to user A are separate advertisement 1, advertisement 2, and advertisement 3. If a descending sequence of correlations between the advertisements and user A is advertisement 1, advertisement 2, and advertisement 3, correspondingly, a descending priority of a delivery sequence for delivering advertisements to user A is advertisement 1, advertisement 2, and advertisement 3.

The comparison result between the actual delivery volume and the target delivery volume of the media file may reflect the correlation between the media file and the delivery object. Specifically, when the actual delivery volume of the media file is less than the target delivery volume, if the media file may win exposure of the delivery object, it indicates that the correlation between the media file and the delivery object is relatively high; and when the actual delivery volume of the media file is greater than the target delivery volume, if the media file cannot win exposure of the delivery object, it indicates that the correlation between the media file and the delivery object is relatively low.

In this embodiment of the present disclosure, the correlation parameter of the media file is adjusted according to the comparison result between the target delivery volume and the actual delivery volume of the media file, so as to adjust the correlation between the media file and the delivery object to further adjust the delivery sequence of the media file.

As an optional embodiment, FIG. 6 is a schematic diagram of another optional apparatus for delivering a media file according to an embodiment of the present disclosure. As shown in FIG. 6, the adjusting module 26 may include: an increasing module 261, configured to increase the value of the correlation parameter when the comparison result indicates that the actual delivery volume is less than the target delivery volume, a delivery sequence determined by the correlation parameter before the value is increased being later than a delivery sequence determined by the correlation parameter after the value is increased; and a decreasing module 263, configured to decrease the value of the correlation parameter when the comparison result indicates that the actual delivery volume is greater than the target delivery volume, a delivery sequence determined by the correlation parameter before the value is decreased being earlier than a delivery sequence determined by the correlation parameter after the value is decreased.

It should be noted that, the increasing module 261 in this embodiment may be configured to perform step S206, sub-step 1 in Embodiment 1 of the present application, and the decreasing module 263 in this embodiment may be configured to perform step S206, sub-step 3 in Embodiment 1 of the present application.

It should be noted that, the comparison result obtained by comparing the target delivery volume with the actual delivery volume of the media file may include: The actual delivery volume is less than or greater than the target delivery volume. When actual delivery volume is less than the target delivery volume (e.g., the actual delivery volume is less than the target delivery volume by a first preset threshold), in this embodiment of the present disclosure, the correlation between the media file and the delivery object may be improved, and it is more likely that the media file is delivered. That is, when the correlation between the media file and the delivery object is relatively high, the media file needs to be preferentially delivered. In this case, in this embodiment of the present disclosure, the value of the correlation parameter of the media file may be increased to improve the priority of the delivery sequence of the media file, so that the delivery sequence corresponding to the correlation indicated after the value of the correlation parameter of the media file is increased is earlier than the delivery sequence corresponding to the correlation indicated before the value is increased. When the actual delivery volume is greater than the target delivery volume (e.g., the actual delivery volume is greater than the target delivery volume by a second preset threshold, where both the first preset threshold and the second preset threshold are greater than 0, and the first preset threshold and the second preset threshold may be the same or different), it indicates that the media file cannot be exposed by the delivery object. That is, when the correlation between the media file and the delivery object is relatively low, the media file needs to be delivered in a later sequence. In this case, in this embodiment of the present disclosure, the value of the correlation parameter of the media file may be decreased to reduce the priority of the delivery sequence of the media file, so that the delivery sequence corresponding to the correlation indicated after the value of the correlation parameter of the media file is decreased is later than the delivery sequence corresponding to the correlation indicated before the value is decreased. It should be noted that, this embodiment of the present disclosure does not specifically limit the first preset threshold and the second preset threshold, and the first preset threshold and the second preset threshold may be set according to an actual requirement. Further, it should be noted that, a difference value by which the actual delivery volume of the media file is less than the target delivery volume may be the same as or may be different from a difference value by which the actual delivery volume is greater than the target delivery volume. This is not specifically limited herein.

In this embodiment of the present disclosure, the value of the correlation parameter of the media file is adjusted according to the comparison result between the actual delivery volume and the target delivery volume of the media file, to adjust the delivery sequence of the media file, so that a media file with a higher correlation to the delivery object may be preferentially delivered, and a media file with a lower correlation to the delivery object may be delivered later, so as to achieve the effect of increasing an exposure rate of the media file to improve the delivery efficiency of the media file.

In the technical solution provided by the delivery module 28, the correlation parameter of the media file may be used to indicate the correlation between the media file and the delivery object. In this embodiment of the present disclosure, the delivery sequence of the media file with a higher correlation to the delivery object is put ahead, the delivery sequence of the media file with a lower correlation to the delivery object is put forward, and the media files are delivered according to the adjusted delivery sequences. It should be noted that, there may be one or more media files delivered to a delivery object. When multiple media files are delivered to a delivery object, a delivery sequence of the media files may be adjusted according to values of correlation parameters of the media files, so that a media file with a larger value of the correlation parameter is preferentially delivered, to increase the exposure rate of the delivery object for the media file to improve the delivery efficiency of the media file.

Optionally, in this embodiment of the present disclosure, when the media file is delivered to the delivery object according to the delivery sequence corresponding to the correlation indicated by a related parameter of the media file, a delivery manner may be selected according to the type of the delivery object. This embodiment of the present disclosure does not specifically limit the type of the delivery object, which may be a web page user, an application user, or the like. This embodiment of the present disclosure also does not specifically limit the delivery manner for delivering the media file to the delivery object. The media file may be automatically displayed in a pop-up form, or a user may be prompted to view the delivered media file in a message prompt form, or the delivered media file may be displayed when an application starts. The delivery manner of the media file may be set or adjusted according to the type of the media file, the type of the delivery object, and the type of a terminal in which the delivery object is located.

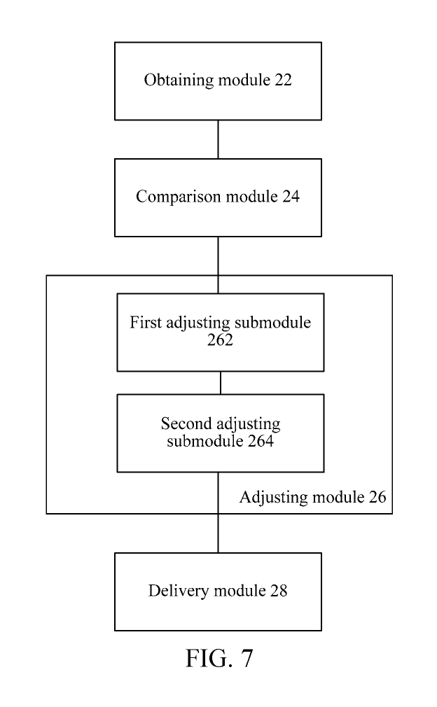

As an optional embodiment, FIG. 7 is a schematic diagram of still another optional apparatus for delivering a media file according to an embodiment of the present disclosure. As shown in FIG. 7, the adjusting module 26 may include: a first adjusting submodule 262, configured to adjust a delivery control parameter according to the comparison result to obtain an adjusted delivery control parameter, the comparison result being used to increase or decrease the value of the delivery control parameter by a first preset proportion; and a second adjusting submodule 264, configured to adjust a correlation parameter of the media file according to the adjusted delivery correlation parameter, the adjusted delivery correlation parameter being used to increase or decrease the value of the correlation parameter by a second preset proportion.

It should be noted that, the first adjusting submodule 262 in this embodiment may be configured to perform step S206, sub-step 2 in Embodiment 1 of the present application, and the second adjusting submodule 264 in this embodiment may be configured to perform step S206, sub-step 4 in Embodiment 1 of the present application.

In the technical solution provided by the first adjusting submodule 262, the delivery control parameter may be used to indicate a delivery speed of the media file. The value of the delivery control parameter may be adjusted according to the comparison result between the actual delivery volume and the target delivery volume of the media file. Specifically, when the actual delivery volume of the media file is less than the target delivery volume, it indicates that the delivery speed of the media file at this time is excessively slow, and the value of the delivery control parameter needs to be increased; and when the actual delivery volume of the media file is greater than the target delivery volume, it indicate that the delivery speed of the media file at this time is excessively fast, and the value of the delivery control parameter needs to be decreased. Optionally, the increase or decrease amplitude of the value of the delivery control parameter may be determined according to the difference value between the actual delivery volume and the target delivery volume of the media file. In this embodiment of the present disclosure, optionally, the value of the delivery control parameter is increased or decreased by a first preset proportion. The amplitude of the first preset proportion may be determined according to the difference value between the actual delivery volume and the target delivery volume of the media file. For example, the first preset proportion may be 0.5%. It should be noted that, the proportions by which the value of the delivery control parameter is increased and decreased may be the same, and are a first preset proportion, or may be different. The proportions by which the value of the delivery control parameter may be specifically set according to an actual situation, and are not specifically limited in this embodiment of the present disclosure.

In the technical solution provided by the second adjusting submodule 264, in the present disclosure, the correlation parameter of the media file may be adjusted according to the adjusted delivery control parameter. When the delivery control parameter is increased by the first preset proportion, the value of the correlation parameter of the media file may be correspondingly increased by the second preset proportion; and when the delivery control parameter is decreased by the first preset proportion, the value of the correlation parameter of the media file may be correspondingly decreased by the second preset proportion. It should be noted that, the first preset proportion may be the same as or may be different from the second preset proportion. This embodiment of the present disclosure does not specifically limit the second preset proportion, which may be set or adjusted according to an actual situation.

It should be noted that, when the actual delivery volume of the media file is less than the target delivery volume, it indicates that the delivery speed of the media file is excessively slow, the media file may be exposed by the delivery object, and the correlation between the media file and the delivery object is relatively high. In this case, the value of the delivery control parameter needs to be increased, and the increased proportion may be the first preset proportion, so that the value of the correlation parameter of the media file is increased, and the increased proportion may be the second preset proportion, so that it may be ensured that the media file can be preferentially delivered to the delivery object, to improve the efficiency of the media file. On the contrary, when the actual delivery volume of the media file is greater than the target delivery volume, it indicates that the delivery speed of the media file is excessively fast, the media file cannot be exposed by the delivery object, and the correlation between the media file and the delivery object is relatively low. In this case, the value of the delivery control parameter needs to be decreased, and the decreased proportion may be the first preset proportion, so that the value of the correlation parameter of the media file is decreased, and the decreased proportion may be the second preset proportion, so that it may be ensured that the delivery sequence of the media file with a lower correlation to the delivery object is put forward, to ensure preferentially delivering the media file with a higher correlation to the delivery object and with the forward sequence, to further improve the efficiency of the media file.

As an optional embodiment, the correlation parameter of the media file may be adjusted according to the following formula:

score(u,ad)=score(u,ad)×α,

where score(u,ad) is the correlation parameter of the media file, and α is the delivery control parameter, used to indicate a delivery speed of the media file, where

$$α = \{ \begin{matrix}α \times {β}^{+} , & \begin{matrix}The actual delivery volume is less \\ than the target delivery volume\end{matrix} \\ α \times {β}^{-} , & \begin{matrix}The actual delivery volume is greater \\ than the target delivery volume\end{matrix}\end{matrix}$$

where β⁺ is a first coefficient, β⁺>1, β⁻ is a second coefficient, and β⁻<1.

It should be noted that, an initial value of the delivery control parameter α may be 1, a change interval of α may be [1, 5], β⁺ is a coefficient greater than 1 and the value may be 1.05, and β⁻ may be a coefficient less than 1 and the value may be 0.95. It should be noted that, the values of the foregoing parameters are all an optional embodiment of the present disclosure. The values of the foregoing parameters may also be adjusted according to a situation. When the actual delivery volume of the media file is less than the target delivery volume (e.g., the actual delivery volume is less than the target delivery volume by the first preset threshold), the value of the delivery control parameter α may be increased by the first preset proportion, so that the correlation parameter score(u,ad) of the media file may also be increased by the second preset proportion. When the actual delivery volume of the media file is greater than the target delivery volume (e.g., the actual delivery volume is greater than the target delivery volume by the second preset threshold), the value of the delivery control parameter α may be decreased by the first preset proportion, so that the correlation parameter score(u,ad) of the media file may also be decreased by the second preset proportion.

It should be noted that, the foregoing manner of calculating the correlation parameter of the media file is only an optional embodiment of the embodiments of the present disclosure. In this embodiment of the present disclosure, the correlation parameter of the media file may also be calculated by using another manner. In the optional embodiment, by calculating the correlation parameter of the media file, the priority of the delivery sequence of the media file may be adjusted according to the correlation parameter, so that a media file with a higher correlation to the delivery object is preferentially delivered, to achieve the effect of improving an exposure volume of multimedia, to further improve the delivery efficiency of the media file.

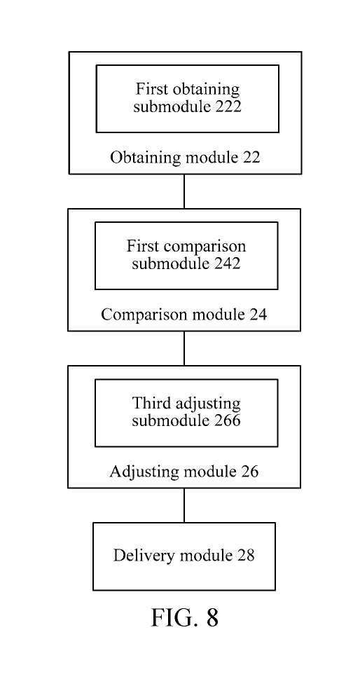

As an optional embodiment, FIG. 8 is a schematic diagram of yet another optional apparatus for delivering a media file according to an embodiment of the present disclosure. As shown in FIG. 8, the obtaining module 22 may include: a first obtaining submodule 222, configured to obtain the target delivery volume and the actual delivery volume of the media file every once in a preset time; the comparison module 24 may include: a first comparison submodule 242, configured to compare the target delivery volume with the actual delivery volume every once in the preset time; and the adjusting module 26 may include: a third adjusting submodule 266, configured to adjust the correlation parameter of the media file according to the comparison result every once in the preset time.

It should be noted that, the first obtaining submodule 222 in this embodiment may be configured to perform step S202, sub-step 2 in Embodiment 1 of the present application, the first comparison submodule 242 in this embodiment may be configured to perform step S204, sub-step 2 in Embodiment 1 of the present application, and the third adjusting submodule 266 in this embodiment may be configured to perform step S206, sub-step 6 in Embodiment 1 of the present application.

It should be noted that, the preset time in the optional embodiment may be set or adjusted according to an actual situation. The preset time may be 1 minute, 30 seconds, or the like, and is not specifically limited herein. In the method for delivering a media file n the optional embodiment, the foregoing steps are performed every once in a preset time, to adjust the correlation parameter of the media file every once in the preset time, to achieve the effect of improving the accuracy of the correlation parameter of the media file, to improve the precision of adjusting the delivery sequence of the media file.

Herein, it should be noted that, the examples and application scenarios implemented by the foregoing modules and corresponding steps are the same, but are not limited to the content disclosed in the foregoing Embodiment 1. It should be noted that, the foregoing modules may run in the hardware environment shown in FIG. 1 as a part of the apparatus, may be implemented by using software, or may be implemented by using hardware. The hardware environment includes a network environment.

### Embodiment 3

According to this embodiment of the present disclosure, a terminal configured to implement the foregoing method for delivering a media file is further provided.

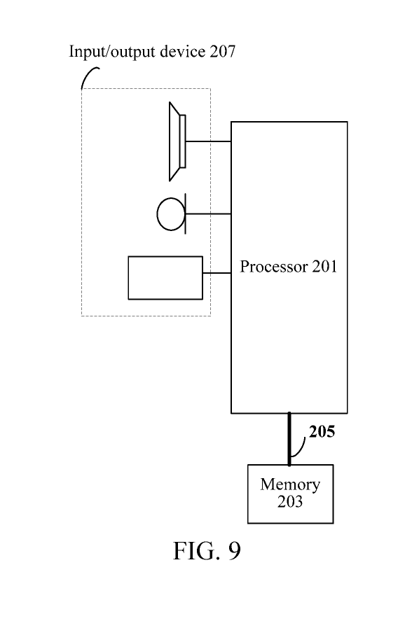

FIG. 9 is a structural block diagram of a terminal according to an embodiment of the present disclosure. As shown in FIG. 9, the terminal may include: processing circuitry such as one or more (only one shown in the figure) processors 201, a memory 203, and a transmission apparatus 205. As shown in FIG. 9, the terminal may further include an input/output device 207.

The memory 203 may be configured to store a software program and a module, for example, a program instruction/module corresponding to a method and an apparatus for delivering a media file in the embodiments of the present disclosure. The processor 201 performs various functional applications and data processing by running the software program and the module stored in the memory 203, that is, implementing the foregoing method for delivering a media file. The memory 203 may include a high-speed random memory, and may also include a nonvolatile memory such as one or more magnetic storage devices, a flash memory, or another nonvolatile solid-state memory. In some embodiments, the memory 203 may further include memories remotely disposed relative to the processor 201, and these remote memories may be connected to the terminal through a network. Instances of the network include, but are not limited to, the Internet, an intranet, a local area network, a mobile communications network, and a combination thereof.

The transmission apparatus 205 is configured to receive or send data through a network, and may also be configured to transmit data between the processor and the memory. Specific examples of the network may include a wired network and a wireless network. In an example, the transmission apparatus 205 includes a network interface controller (NIC) that may be connected to another network device and a router by using a network cable, thereby communicating with the Internet or a local area network. In an example, the transmission apparatus 205 is a radio frequency (RF) module that is configured to communicate with the Internet in a wireless manner.

Specifically, the memory 203 is configured to store an application program.

The processor 201 may invoke the application program stored memory 203 by using the transmission apparatus 205, to perform the following steps: obtaining a target delivery volume and an actual delivery volume of a media file; comparing the target delivery volume with the actual delivery volume to obtain a comparison result; adjusting a correlation parameter of the media file according to comparison result, the correlation parameter being used to indicate a correlation between the media file and a delivery object of the media file; and delivering the media file, a delivery sequence of the media file being determined according to the correlation parameter.

The processor 201 is further configured to perform the following steps: increasing the value of the correlation parameter when the comparison result indicates that the actual delivery volume is less than the target delivery volume, a delivery sequence determined by the correlation parameter before the value is increased being later than a delivery sequence determined by the correlation parameter after the value is increased; and decreasing the value of the correlation parameter when the comparison result indicates that the actual delivery volume is greater than the target delivery volume, a delivery sequence determined by the correlation parameter before the value is decreased being earlier than a delivery sequence determined by the correlation parameter after the value is decreased.

The processor 201 is further configured to perform the following step: adjusting the correlation parameter of the media file according to the following formula: score(u,ad)=score(u,ad)×α, where score(u,ad) is the correlation parameter of the media file, α is the delivery control parameter, used to indicate a delivery speed of the media file, where

$$α = \{ \begin{matrix}α \times {β}^{+} , & \begin{matrix}The actual delivery volume is less \\ than the target delivery volume\end{matrix} \\ α \times {β}^{-} , & \begin{matrix}The actual delivery volume is greater \\ than the target delivery volume\end{matrix}\end{matrix} ,$$

where β⁺ is a first coefficient, β⁺22 1, β⁻ is a second coefficient, and β⁻<1.

The processor 201 is further configured to perform the following steps: obtaining the target delivery volume and the actual delivery volume of the media file every once in a preset time; comparing the target delivery volume with the actual delivery volume every once in the preset time; and adjusting the correlation parameter of the media file according to the comparison result every once in the preset time.

The processor 201 is further configured to perform the following step: obtaining the target delivery volume of the media file according to the following formula:

$$paced\_exp o = \frac{{\int }_{{t}_{start}}^{{t}_{curr}} c ( t ) dt}{{\int }_{{t}_{start}}^{{t}_{end}} c ( t ) dt} \times exp o\_num$$

where c(t) is an exposure opportunity curve of is the media file, tₛₜₐᵣₜ a delivery start time of the media file, t_{end} is a delivery end time of the media file, t_{curr} is a current time, expo_num is a total volume of to-be delivered media files, and paced_expo is the target delivery volume of the media file from the delivery start time to the current time.

This embodiment of the present disclosure provides a solution for delivering a media file. The correlation parameter of the media file is adjusted according to the comparison result of the target delivery volume and the actual delivery volume of the media file, and the media file is delivered according to the correlation between the media file indicated by the correlation parameter and the delivery object, to deliver the media file to a delivery object with a relatively high correlation on the basis of ensuring an exposure volume of the media file, so as to achieve the technical effect of improving the delivery precision of the media file to further improve the delivery efficiency of the media file, to further resolve the technical problem of the related technology that the media file may be delivered to a delivery object with a relatively low correlation to ensure the exposure volume of the media file.

Optionally, for specific examples of this embodiment, reference may be made to the examples described in Embodiment 1 and Embodiment 2. Details are not described again in this embodiment.

A person of ordinary skill in the art may understand that, the structure shown in FIG. 9 is only schematic. The terminal may be a terminal device such as a smartphone (such as an Android mobile phone or an iOS mobile phone), a tablet computer, a palmtop computer, a mobile Internet device (MID), or a PAD. FIG. 9 does not limit the structure of the foregoing electronic apparatus. For example, the terminal may further include more or less components (such as a network interface and a display apparatus) than those shown in FIG. 9, or has a configuration different from that shown in FIG. 9.

A person of ordinary skill in the art may understand that all or a part of the steps of the methods of the foregoing embodiments may be implemented by a program instructing relevant hardware of the terminal device. The program may be stored in a computer readable storage medium. The storage medium may be a flash disk, a read-only memory (ROM), a random access memory (RAM), a magnetic disk, or an optical disc.

### Embodiment 4

This embodiment of the present disclosure further provides a storage medium. Optionally, in this embodiment, the storage medium may be configured to execute program code in a method for delivering a media file.

Optionally, in this embodiment, the storage medium may be located on at least one of multiple network devices in the network shown in the foregoing embodiment.

Optionally, in this embodiment, the storage medium is configured to store program code used to perform the following steps:

1. Obtain a target delivery volume and an actual delivery volume of a media file.

2. Compare the target delivery volume with the actual delivery volume to obtain a comparison result.

3. Adjust a correlation parameter of the media file according to the comparison result, the correlation parameter being used to indicate a correlation between the media file and a delivery object of the media file.

4. Deliver the media file, a delivery sequence of the media file being determined according to the correlation parameter.

Optionally, the storage medium is further configured to store program code used to perform the following steps: increasing the value of the correlation parameter when the comparison result indicates that the actual delivery volume is less than the target delivery volume, a delivery sequence determined by the correlation parameter before the value is increased being later than a delivery sequence determined by the correlation parameter after the value is increased; and decreasing the value of the correlation parameter when the comparison result indicates that the actual delivery volume is greater than the target delivery volume, a delivery sequence determined by the correlation parameter before the value is decreased being earlier than a delivery sequence determined by the correlation parameter after the value is decreased.

Optionally, the storage medium is further configured to store program code used to perform the following steps: adjusting the correlation parameter of the media file according to the following formula: score(u,ad)=score(u,ad)×α, where score(u,ad) is the correlation parameter of the media file, α is the delivery control parameter, used to indicate a delivery speed of the media file, where

$$α = \{ \begin{matrix}α \times {β}^{+} , & \begin{matrix}The actual delivery volume is less \\ than the target delivery volume\end{matrix} \\ α \times {β}^{-} , & \begin{matrix}The actual delivery volume is greater \\ than the target delivery volume\end{matrix}\end{matrix} ,$$

where β⁺ is a first coefficient, β⁺>1, β⁻ is a second coefficient, and β⁻>1.

Optionally, the storage medium is further configured to store program code used to perform the following steps: obtaining the target delivery volume and the actual delivery volume of the media file every once in a preset time; comparing the target delivery volume with the actual delivery volume every once in the preset time; and adjusting the correlation parameter of the media file according to the comparison result every once in the preset time.

Optionally, the storage medium is further configured to store program code used to perform the following step: obtaining the target delivery volume of the media file according to the following formula:

$$paced\_exp o = \frac{{\int }_{{t}_{start}}^{{t}_{curr}} c ( t ) dt}{{\int }_{{t}_{start}}^{{t}_{end}} c ( t ) dt} \times exp o\_num$$

where c(t) is an exposure opportunity curve of the media file, tₛₜₐᵣₜ is a delivery start time of the media file, t_{end} is a delivery end time of the media file, t_{curr} is a current time, expo_num is a total volume of to-be-delivered media files, and paced_expo is a target delivery volume of the media file from the delivery start time to the current time.

Optionally, for specific examples of this embodiment, reference may be made to the examples described in Embodiment 1 and Embodiment 2. Details are not described again in this embodiment.

Optionally, in this embodiment, the storage medium may include but is not limited to various media that may store program code, such as a USB flash disk, a read-only memory (ROM), a random access memory (RAM), a removable hard disk, a magnetic disk, or an optical disc.

The sequence numbers of the foregoing embodiments of the present disclosure are merely for description purpose but do not indicate the preference of the embodiments.

When the units integrated in the foregoing embodiments are implemented in a form of a software functional module and sold or used as an independent product, the units may be stored in a computer-readable storage medium. Based on such an understanding, all or some of the technical solutions may be implemented in a form of a software product. The computer software product is stored in a storage medium and includes several instructions for instructing one or more computer devices (which may be a personal computer, a server, a network device, or the like) to perform all or some of the steps of the methods described in the embodiments of the present disclosure.

In the foregoing embodiments of the present disclosure, descriptions of the embodiments have different emphases, and for parts that are not described in detail in one embodiment, reference may be made to the relevant description of the other embodiments.

In the several embodiments provided in the present application, it should be understood that the disclosed client may be implemented in other manners. The described apparatus embodiments are merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and the parts displayed as units may or may not be physical units, may be located in one position, or may be distributed on a plurality of network units. A part of or all of the units may be selected according to actual needs to achieve the objectives of the solutions of the embodiments.

In addition, functional units in the embodiments of the present disclosure may be integrated into one processing unit, or each of the units may exist alone physically, or two or more units may be integrated into one unit. The integrated unit may be implemented in a form of hardware, or may be implemented in a form of a software functional unit.

The foregoing descriptions are merely exemplary embodiments of the present disclosure, and it should be noted that, a person of ordinary skill in the art may make various improvements and refinements without departing from the principle of the present disclosure. All such modifications and refinements should also fall within the protection scope of the present disclosure.

What is claimed is:

1. A method for delivering a media file, comprising:
obtaining, by processing circuitry in an information processing apparatus, a target delivery volume and an actual delivery volume of the media file corresponding to a same period of time;
comparing, by the processing circuitry in the information processing apparatus, the target delivery volume with the actual delivery volume to obtain a comparison result;
adjusting, by the processing circuitry in the information processing apparatus, a correlation parameter of the media file according to the comparison result, the correlation parameter indicating a correlation between the media file and a delivery object of the media file; and
delivering the media file to the delivery object according to the adjusted correlation parameter.

2. The method according to claim 1, wherein the adjusting the correlation parameter of the media file according to the comparison result includes:
increasing a value of the correlation parameter when the comparison result indicates that the actual delivery volume is less than the target delivery volume.

3. The method according to claim 1, wherein the adjusting the correlation parameter of the media file according to the comparison result comprises:
decreasing a value of the correlation parameter when the comparison result indicates that the actual delivery volume is greater than the target delivery volume.

4. The method according to claim 1, wherein the adjusting the correlation parameter of the media file according to the comparison result comprises:
adjusting a delivery control parameter according to the comparison result to obtain an adjusted delivery control parameter; and
adjusting the correlation parameter of the media file according to the adjusted delivery correlation parameter.

5. The method according to claim 4, wherein the correlation parameter of the media file is adjusted according to the following formula:
score(u,ad)=score(u,ad)×α
wherein score(u,ad) is the correlation parameter of the media file, and α is the delivery control parameter used to indicate a delivery speed of the media file, wherein
$$α = \{ \begin{matrix}α \times {β}^{+} , & \begin{matrix}when the actual delivery volume is less \\ than the target delivery volume\end{matrix} \\ α \times {β}^{-} , & \begin{matrix}when the actual delivery volume is greater \\ than the target delivery volume\end{matrix}\end{matrix}$$
wherein β⁺ is a first coefficient, β⁺>1, β⁻ is a second coefficient, and β⁻<1.

6. The method according to claim 1, wherein the delivering the media file to the delivery object according to the adjusted correlation parameter comprises:
determining a delivery order of the media file among a group of media files to be delivered to the delivery object according to the adjusted correlation parameter; and
delivering the media file to the delivery object according to the determined delivery order.

7. The method according to claim 1, wherein the target delivery volume of the media file is obtained according to the following formula:
$$paced\_exp o = \frac{{\int }_{{t}_{start}}^{{t}_{curr}} c ( t ) dt}{{\int }_{{t}_{start}}^{{t}_{end}} c ( t ) dt} \times exp o\_num$$
wherein c(t) is an exposure opportunity curve of the media file, tₛₜₐᵣₜ a delivery start time of the media file, t_{end} is a delivery end time of the media file, t_{curr} is a current time, expo_num is a total volume of to-be-delivered media files during a time period from tₛₜₐᵣₜ to t_{end}, and paced_expo is the target delivery volume of the media file from the delivery start time to the current time.

8. An apparatus, comprising processing circuitry configured to:
obtain a target delivery volume and an actual delivery volume of the media file corresponding to a same period of time;
compare the target delivery volume with the actual delivery volume to obtain a comparison result;
adjust a correlation parameter of the media file according to the comparison result, the correlation parameter indicating a correlation between the media file and a delivery object of the media file; and
deliver the media file to the delivery object according to the adjusted correlation parameter.

9. The apparatus according to claim 8, wherein the processing circuitry is further configured to:
increase a value of the correlation parameter when the comparison result indicates that the actual delivery volume is less than the target delivery volume.

10. The apparatus according to claim 8, wherein the processing circuitry is further configured to:
decrease a value of the correlation parameter when the comparison result indicates that the actual delivery volume is greater than the target delivery volume.

11. The apparatus according to claim 8, wherein the processing circuitry is further configured to:
adjust a delivery control parameter according to the comparison result to obtain an adjusted delivery control parameter; and
adjust the correlation parameter of the media file according to the adjusted delivery correlation parameter.

12. The apparatus according to claim 11, wherein the correlation parameter of the media file is adjusted according to the following formula:
score(u,ad)=score(u,ad)×α
wherein score(u,ad) is the correlation parameter of the media file, and α is the delivery control parameter used to indicate a delivery speed of the media file, wherein
$$α = \{ \begin{matrix}α \times {β}^{+} , & \begin{matrix}when the actual delivery volume is less \\ than the target delivery volume\end{matrix} \\ α \times {β}^{-} , & \begin{matrix}when the actual delivery volume is greater \\ than the target delivery volume\end{matrix}\end{matrix}$$
wherein β⁺ is a first coefficient, β⁺>1, β⁻ is a second coefficient, and β⁻>1.

13. The apparatus according to claim 8, wherein the processing circuitry is further configured to:
determine a delivery order of the media file among a group of media files to be delivered to the delivery object according to the adjusted correlation parameter; and
deliver the media file to the delivery object according to the determined delivery order.

14. The apparatus according to claim 8, wherein the target delivery volume of the media file is obtained according to the following formula:
$$paced\_exp o = \frac{{\int }_{{t}_{start}}^{{t}_{curr}} c ( t ) dt}{{\int }_{{t}_{start}}^{{t}_{end}} c ( t ) dt} \times exp o\_num$$
wherein c(t) is an exposure opportunity curve of the media file, tₛₜₐᵣₜ is a delivery start time of the media file, t_{end} is a delivery end time of the media file, t_{curr} is a current time, expo_num is a total volume of to-be-delivered media files during a time period from tₛₜₐᵣₜ to t_{end}, and paced_expo is the target delivery volume of the media file from the delivery start time to the current time.

15. A non-transitory computer-readable medium storing a program executable by a processor to perform:
obtaining a target delivery volume and an actual delivery volume of the media file corresponding to a same period of time;
comparing the target delivery volume with the actual delivery volume to obtain a comparison result;
adjusting a correlation parameter of the media file according to the comparison result, the correlation parameter indicating a correlation between the media file and a delivery object of the media file; and
delivering the media file to the delivery object according to the adjusted correlation parameter.

16. The non-transitory computer-readable medium according to claim 15, wherein the program is executable by the processor to further perform:
increasing a value of the correlation parameter when the comparison result indicates that the actual delivery volume is less than the target delivery volume.

17. The non-transitory computer-readable medium according to claim 15, wherein the program is executable by the processor to further perform:
decreasing a value of the correlation parameter when the comparison result indicates that the actual delivery volume is greater than the target delivery volume.

18. The non-transitory computer-readable medium according to claim 15, wherein the program is executable by the processor to further perform:
adjusting a delivery control parameter according to the comparison result to obtain an adjusted delivery control parameter; and
adjusting the correlation parameter of the media file according to the adjusted delivery correlation parameter.

19. The non-transitory computer-readable medium according to claim 18, wherein the correlation parameter of the media file is adjusted according to the following formula:
score(u,ad)=score(u,ad)×α
wherein score(u,ad) is the correlation parameter of the media file, and α is the delivery control parameter used to indicate a delivery speed of the media file, wherein
$$α = \{ \begin{matrix}α \times {β}^{+} , & \begin{matrix}when the actual delivery volume is less \\ than the target delivery volume\end{matrix} \\ α \times {β}^{-} , & \begin{matrix}when the actual delivery volume is greater \\ than the target delivery volume\end{matrix}\end{matrix}$$
wherein β⁺ is a first coefficient, β⁺>1, β⁻ is a second coefficient, and β⁻>1.

20. The non-transitory computer-readable medium according to claim 15, wherein the program is executable by the processor to further perform:
determining a delivery order of the media file among a group of media files to be delivered to the delivery object according to the adjusted correlation parameter; and
delivering the media file to the delivery object according to the determined delivery order.
